(19) United States
(12) Patent Application Publication
(10) Pub. No.: US 2025/0148501 A1
(43) Pub. Date: May 8, 2025

(54) METHODS AND SYSTEMS TO IMPROVE POST OPPORTUNITIES

(71) Applicant: META PLATFORMS, INC., Menlo Park, CA (US)

(72) Inventors: Gregory Vannoni, Phoenix, AZ (US); Giacomo Lami, Burlingame, CA (US); Hongfa Huo, South Glastonbury, CT (US); Shao-Huang Pin, San Jose, CA (US); Shourya Mukherjee, San Francisco, CA (US); Sophie Zheng, Mountain View, CA (US); Hari Sivakumar, Redwood City, CA (US); Prasad Marla, San Jose, CA (US); Chen Liu, Sunnyvale, CA (US); Alessandra Motta, Austin, TX (US); Charles Liam Goudge, Menlo Park, CA (US); Samira Allahverdiyeva, Los Gatos, CA (US); Brandon Herring, Berkley, MI (US); Elif Tekerlekci, San Francisco, CA (US); Hussein Fahmy, London (CA); Nina Ahmed, Seattle, WA (US); Swapnil Subodh Mahajan, San Jose, CA (US)

(21) Appl. No.: 18/890,540

(22) Filed: Sep. 19, 2024

Related U.S. Application Data
(60) Provisional application No. 63/596,118, filed on Nov. 3, 2023.
(60) Provisional application No. 63/613,498, filed on Dec. 21, 2023.

(51) Int. Cl. G06Q 30/0242; G06N 3/0475; G06N 3/08

(52) U.S. Cl. CPC G06Q 30/0244; G06N 3/0475; G06N 3/08

(57) ABSTRACT

The present disclosure provides systems and methods for optimizing media content. One step of the method may include receiving, via a user interface, an indication of a selected post including media content associated with a user. Another step of the method may include evaluating, via a LLM model trained on training data, a quality of the media content of the selected post. A further step may include generating, via the trained LLM model and based upon the evaluated quality, a modified post including modified media content. A change in the modified post is of a first type when the evaluated quality is at or below a threshold or of a second type when the evaluated quality is above a threshold. Even a further step may include transmitting, via the user interface, the modified post for consideration by the user. Yet even a further step may include receiving, via the user interface, an indication of a rejection or an acceptance of the modified post.

### CROSS-REFERENCE TO RELATED APPLICATIONS

The instant application claims the benefit of priority of U.S. Provisional Application No. 63/596,118 filed Nov. 3, 2023 entitled, “Automation to Generate and Proactively Propose Advertising Opportunities,” and U.S. Provisional Application No. 63/613,498 filed Dec. 21, 2023 entitled, “Ad Creative Effectiveness with Large Language Models” the content of which is incorporated by reference in their entireties.

### TECHNOLOGICAL FIELD

The present disclosure generally relates to systems and methods employing generative artificial intelligence for generating media content for a posting, and improving media content of existing postings.

### BACKGROUND

Often times, business owners are not savvy with employing technology to develop media content, such as for example digital advertisements for posting on a social media platform. Some of the primary areas of complexity may include constructing a headline, description, and picture complying with constraints of a host platform. Separately, business owners may be overburdened with limited time and resources to effectively run their business. As a result, business owners may be unsuccessful in attracting target audiences contributing to poor business metrics.

Generally, current media content creation lacks detailed optimization methods resulting in sub-optimal captions and images. This may be attributed to surface level artificial intelligence (AI)-based enhancements regarding.

What is desired in the art is a simplified architecture and method that alleviates pain points in generating media content, more particularly ad creation, to help grow and maintain a business.

What is also desired in the art is a simplified architecture and method to optimize an existing media content posting on a platform.

### BRIEF SUMMARY

One aspect of the subject technology may be directed to a method for optimizing media content. One step of the method may include receiving, via a user interface, an indication of a selected post including media content associated with a user. Another step of the method may include evaluating, via a LLM model trained on training data, a quality of the media content of the selected post. A further step may include generating, via the trained LLM model and based upon the evaluated quality, a modified post including modified media content. A change in the modified post is of a first type when the evaluated quality is at or below a threshold or of a second type when the evaluated quality is above a threshold. Even a further step may include transmitting, via the user interface, the modified post for consideration by the user. Yet even a further step may include receiving, via the user interface, an indication of a rejection or an acceptance of the modified post.

Another aspect of the subject technology may be directed to an apparatus and/or a system for optimizing media content. The apparatus and/or system may include a non-transitory memory including stored instructions. The apparatus and/or system may include a processor operably coupled to the non-transitory memory and configured to execute the store instructions. The processor may be configured to execute a step of receiving, via a user interface, an indication of a selected post including media content associated with a user. The processor may also be configured to execute a step of evaluating, via a LLM model trained on training data, a quality of the media content of the selected post. The processor may be further configured to execute a step of generating, via the trained LLM model and based upon the evaluated quality, a modified post including modified media content. A change in the modified post is of a first type when the evaluated quality is at or below a threshold or of a second type when the evaluated quality is above a threshold. The processor may be even further configured to execute a step of transmitting, via the user interface, the modified post for consideration by the user. The processor may yet even further be configured to execute a step of receiving, via the user interface, an indication of a rejection or an acceptance of the modified post.

Another aspect of the subject technology may be directed to a computer program product. The computer program product may include at least one non-transitory computer-readable medium including computer-executable program code instructions stored therein. The computer-executable program code instructions may include program code instructions configured to receive, via a user interface, an indication of a selected post comprising media content associated with a user. The computer program product may further include program code instructions configured to evaluate, via a large language model trained on training data, a quality of the media content of the selected post. The training data may comprise any one or more of a profile of the user, a profile of a follower of the user, or an attribute of one or more previous posts associated with the user. The computer program product may further include program code instructions configured to generate, via the trained LLM model and based upon the evaluated quality, a modified post comprising modified media content. A change in the modified post may be of a first type when the evaluated quality is at or below a threshold or of a second type when the evaluated quality is above a threshold, and wherein the first type of change is more substantive than the second type of change. The computer program product may further include program code instructions configured to transmit, via the user interface, the modified post for consideration by the user. The computer program product may further include program code instructions configured to receive, via the user interface, an indication of a rejection or an acceptance of the modified post.

Additional advantages will be set forth in part in the description which follows or may be learned by practice. The advantages will be realized and attainted by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates a diagram of an exemplary network environment in accordance with one or more example aspects of the subject technology.

FIG. 2 illustrates a diagram of an exemplary communication device in accordance with one or more example aspects of the subject technology.

FIG. 3 illustrates an exemplary computing system in accordance with one or more example aspects of the subject technology.

FIG. 4 illustrates a machine learning and training model framework in accordance with example aspects of the present disclosure.

FIG. 5 illustrates an advertisement funnel in accordance with one or more example aspects the subject technology.

FIGS. 6A-6B illustrate postings on a platform in accordance with one or more example aspects of the subject technology.

FIG. 7 illustrates an architecture for improving the quality of a post in accordance with one or more example aspects the subject technology.

FIG. 8 illustrates an architecture for generating a new post in accordance with one or more example aspects of the subject technology.

FIG. 9 illustrates a user interface including options for generating a new post in accordance with one or more example aspects of the subject technology.

FIG. 10 illustrates an example flow in accordance with one or more example aspects of the subject technology.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the subject technology will now be described more fully hereinafter with reference to the accompanying drawings, in which some, but not all examples of the subject technology are shown. Indeed, various examples of the subject technology may be embodied in many different forms and should not be construed as limited to the examples set forth herein. Like reference numerals refer to like elements throughout.

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of augmented/virtual/mixed reality.

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

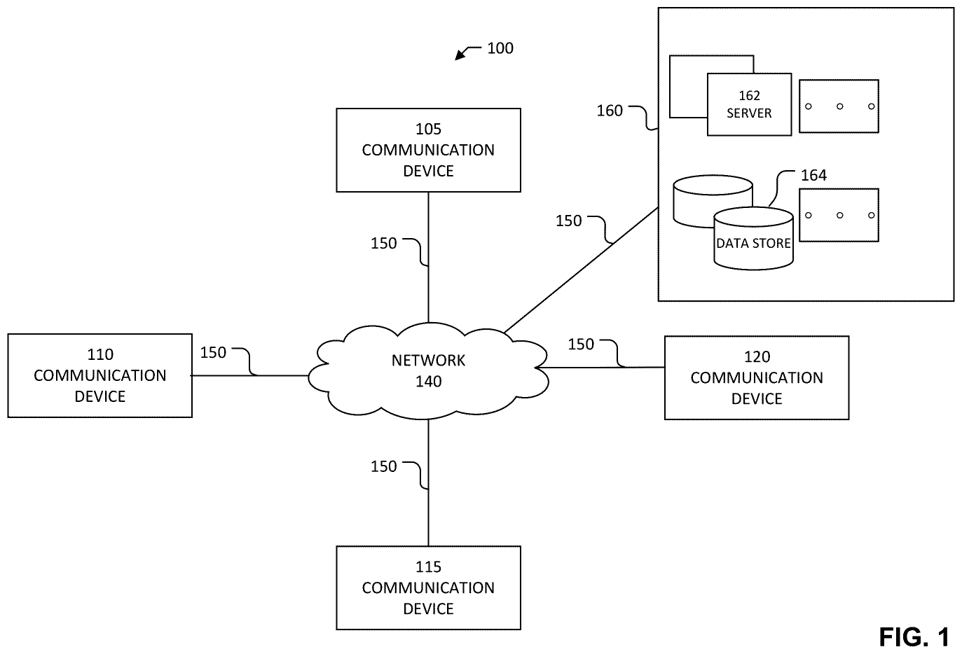

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140. In other examples, the network 140 may be any suitable network capable of provisioning content and/or facilitating communications among entities within, or associated with the network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wired and/or wireless links, such as, for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH). In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as, for example, a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

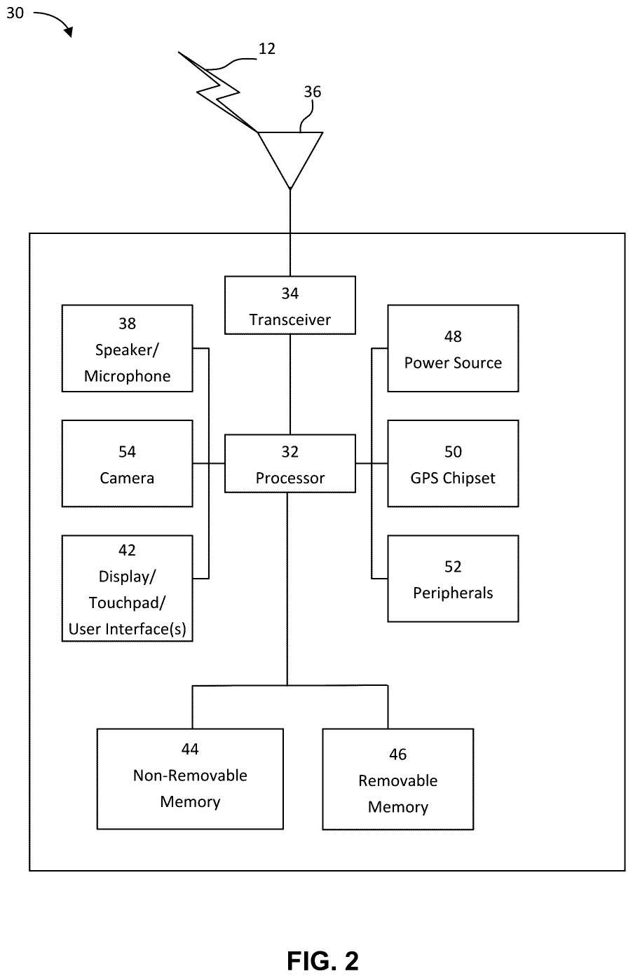

FIG. 2 illustrates a block diagram of an exemplary hardware/software architecture of a communication device such as, for example, user equipment (UE) 30. In some exemplary respects, the UE 30 may be any of communication devices 105, 110, 115, 120. In some exemplary aspects, the UE 30 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a display, touchpad, and/or user interface(s) 42, a power source 48, a GPS chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptacle and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example. The non-removable memory 44 and/or the removable memory 46 may be computer-readable storage mediums. For example, the non-removable memory 44 may include a non-transitory computer-readable storage medium and a transitory computer-readable storage medium.

The processor 32 is coupled to its communication circuitry (e.g., transceiver 34 and transmit/receive element 36). The processor 32, through the execution of computer-executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

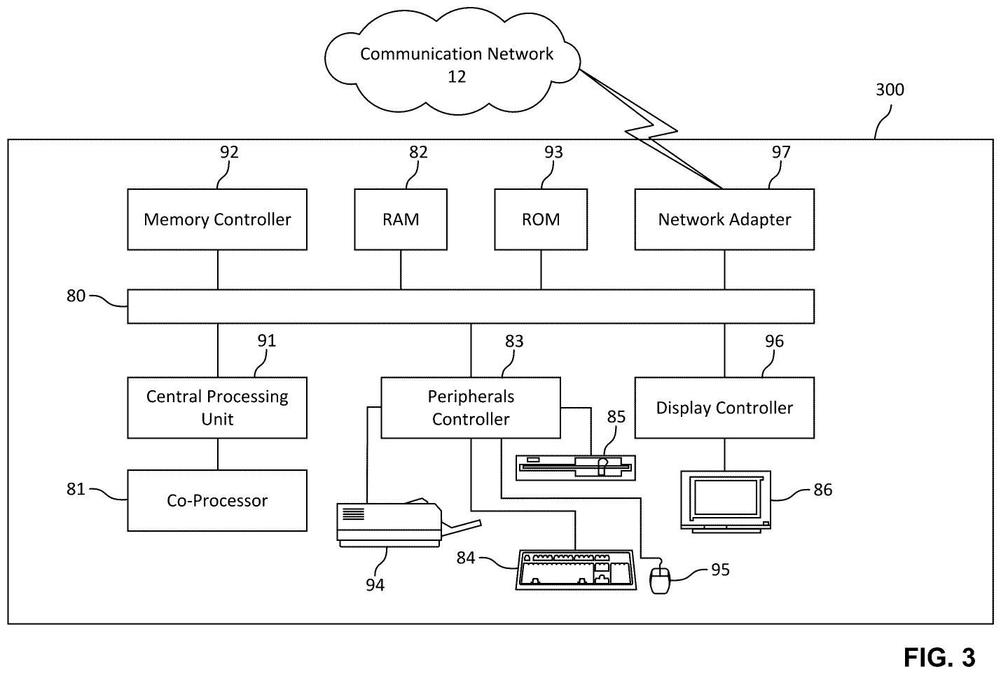

FIG. 3 is a block diagram of an exemplary computing system 300. In some exemplary embodiments, the network device 160 may be a computing system 300. The computing system 300 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adapter 97, that may be used to connect computing system 300 to an external communications network, such as network 12 of FIG. 2, to enable the computing system 300 to communicate with other nodes (e.g., UE 30) of the network.

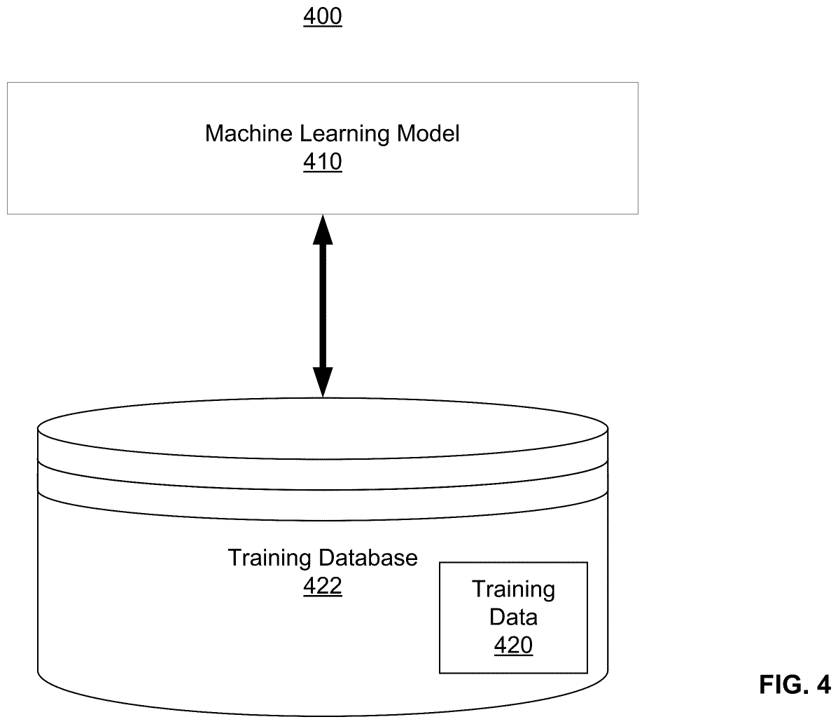

FIG. 4 illustrates a machine learning and training model, in accordance with an example of the present disclosure. The machine learning framework 400 associated with the machine learning model may be hosted remotely. Alternatively, the machine learning framework 400 may reside within a server 162 shown in FIG. 1, or be processed by an electronic device (e.g., head mounted displays, smartphones, tablets, smartwatches, or any electronic device, such as communication device 105). The machine learning model 410 may be communicatively coupled to the stored training data 420 in a memory or database (e.g., ROM, RAM) such as training database 422. In some examples, the machine learning model 410 may be associated with operations of any one or more of the systems/architectures depicted in subsequent figures of the application. In some other examples, the machine learning model 410 may be associated with other operations. The machine learning model 410 may be implemented by one or more machine learning models(s) and/or another device (e.g., a server and/or a computing system). In some embodiments, the machine learning model 410 may be a student model trained by a teacher model, and the teacher model may be included in the training database 422.

### Postings Including Media Content

According to an aspect of the subject technology, generating new media content and improving the quality of existing media content is envisaged. In an example embodiment, the media content may include digital advertisement (e.g., ad) content. It is also envisaged within the spirit of the subject technology to simplify the ad creation process for users who do not appreciate the intricacies of the digital ad space. Doing so shall provide users the opportunity to generate an ad with that is engaging and valuable for consumers. Stated otherwise, the intention is to remove the need of user expertise from the ad creation process by leveraging large language models (LLMs) hosted by an internal generative artificial (GAI) system to produce text with improved click-ability, click-through rate and readability.

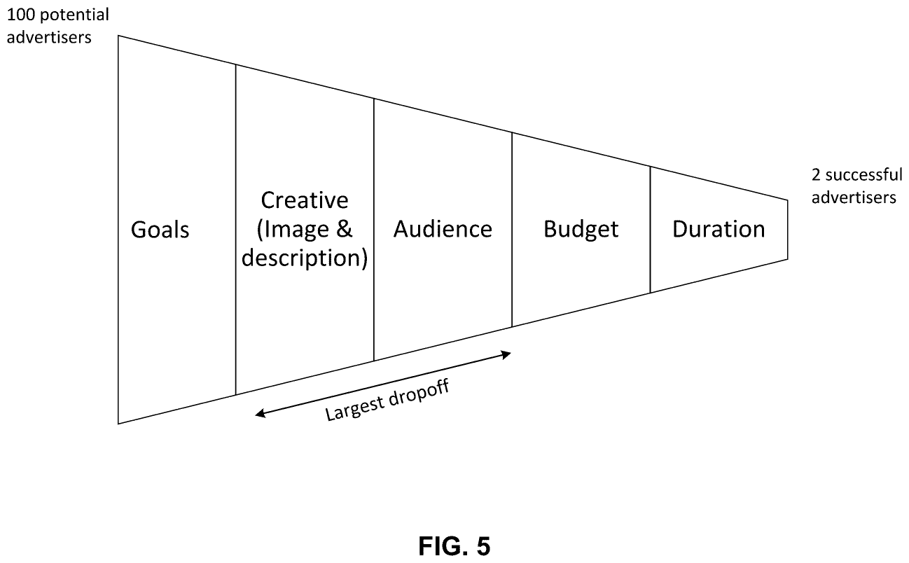

It is common for non-savvy technology users to struggle through the ad content creation process. As shown in FIG. 5, small and medium-sized businesses tend to exhibit a noticeable drop-off in the ad creation funnel (>66%). This is based upon and based upon one hundred potential advertisers. Generally, these drop-offs are largest at the stages of creative development (e.g., the image and description), audience definition and budget settings. Thereafter, FIG. 5 depicts two of the initial one hundred advertisers being successful in or after the duration setting.

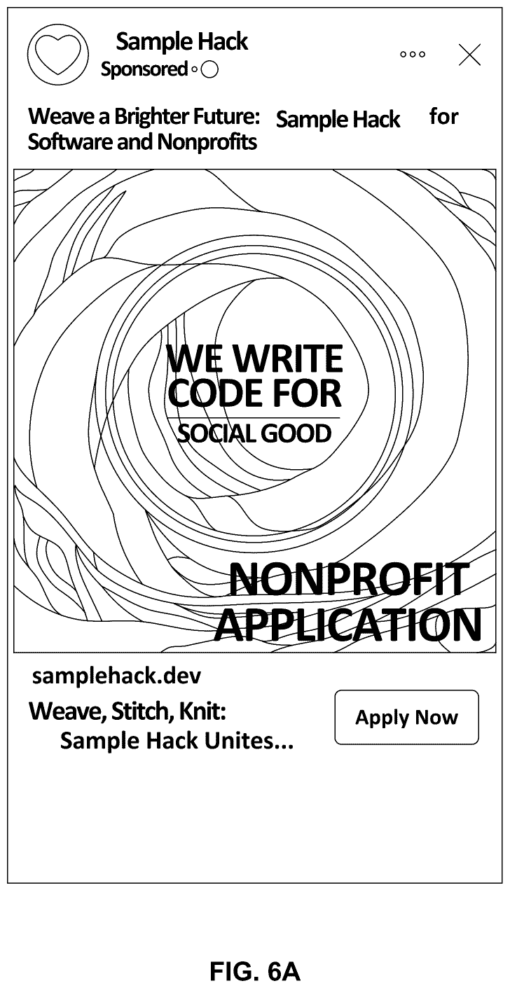

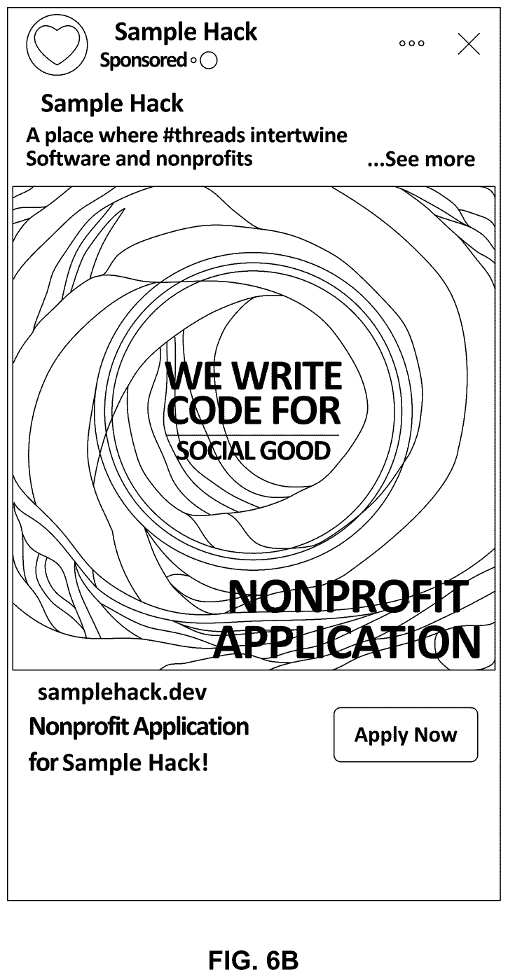

According to another embodiment, an example posting on a social media platform is depicted in FIGS. 6A-6B. As shown, each of the user interfaces (UIs) in FIGS. 6A-6B depicts a landing page for a specific website with a headline.

### Boosting a Post

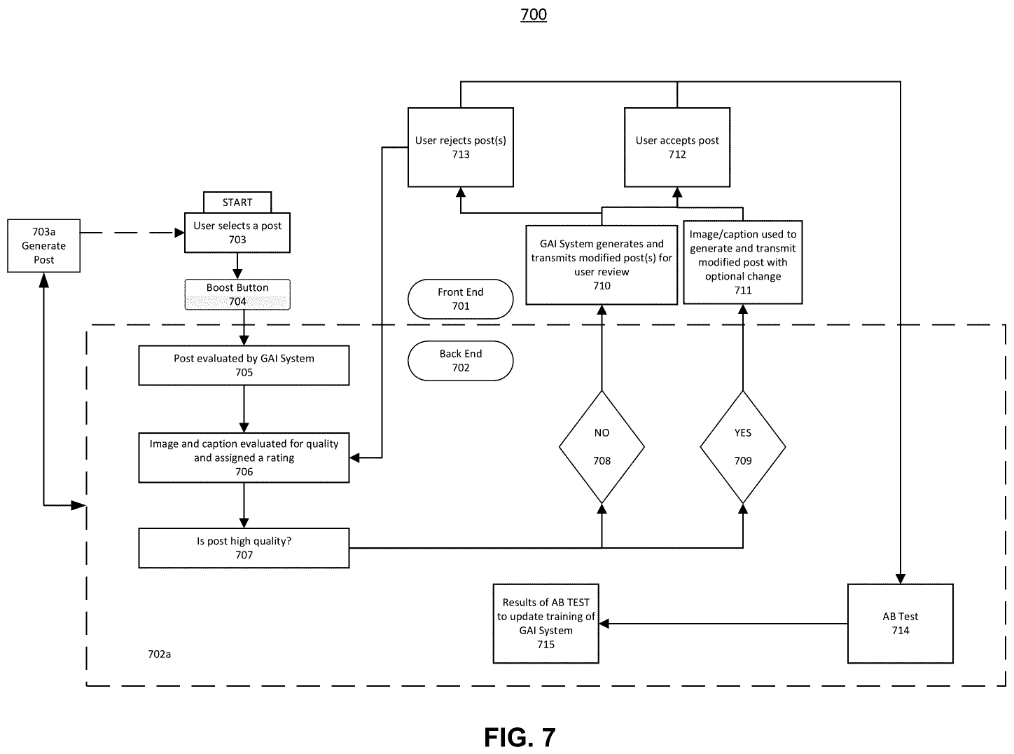

According to an example aspect of the subject technology, FIG. 7 depicts an architecture 700 for boosting media content on a social media platform. The media content may include advertisements. The media content may also include any combination of text, images, videos, or other media content. The user on a front end 701 can be an individual or a business.

Generally the process begins on the front end 701 where a user selects an existing post on their webpage (703), or may generate an entirely new post (703a) as will be discussed in further detail below according to another embodiment of this particular aspect. The selection may be received via a button 704 on a user interface, or alternatively via an audio prompt or any other known manner for making designating a selection. By utilizing this architecture 700 in FIG. 7, the user can boost visibility of their media content on social media platforms potentially leading to increased engagement and conversions.

A GAI system 702a on the back end 702 may also be employed in the architecture 700 depicted in FIG. 7. The GAI system 702a may employ one or more trained LLMs to optimize a process of generating a modified post with modified media content based on an evaluated quality of a provided post.

The LLM model may be trained via billions of token parameters. The token parameters may include training data including any one or more of a profile of the user, a profile of a follower of the user, or an attribute of one or more previous posts associated with the user. The profile of the user may include any one or more of a budget, duration, location of the user, or audience target audience or modality of an offered service. The attribute of one or more previous posts may include any one or more of a heading, wording, formatting, visual or audio enhancements, audience reach, or optimal time of audience engagement.

In an embodiment, the trained LLM model may receive an existing post (705). The trained LLM model may be deployed to provide a score based upon an evaluation of its quality. For instance, an image and caption associated with the selected post are parsed and processed by the LLM model and assigned a rating (706). The post may be rated for its quality (707). According to an embodiment, two use-cases are generated contingent upon the rating. Generally, the system may generate a modified post with modified media content based on the evaluated quality. The modified post is of a first type when the evaluated quality is at or below a threshold, and of a second type when the evaluated quality is above a threshold. The first type of change is more substantive than the second type of change. The first type of change may include one or more optimized views of the media content. Meanwhile, the second type of change may include a single optimized view of the media content.

According to the first use case noted above, the ad is considered low quality (708) if the generated rating is less than or equal to 5 out of 10. The rate is arbitrarily set by system. If the ad is considered low quality, the system may output a selection of modified posts, e.g., optimized ads, for the user to review 710 via the user interface on the front end 701.

Subsequently, the user then has the option of accepting (712) or rejecting (713) the ad content of their choice. The system may receive an indication of a rejection or an acceptance of the modified post via the user interface. If the user accepts the ad content (712) upon review, it may be posted to a social media platform. If, on the other hand, the user rejects the generated ad recommendations (713), the system recognizes the rejection and begins the procedure again (e.g., back to block 706).

According to the second use case noted above, the ad may be considered high quality (709) if the generated rating is greater than or equal to 6 on a scale of 1-10. In this instance, the system may make minor modifications to the post and transmit via the user interface for review by the user (711). Once the post is reviewed and accepted by the user (212) it may be posted to a social media platform.

According to yet another embodiment, and regardless of the user accepting or rejecting the modified post, feedback of the decision may be sent to the back end 702 to block 714 for comparative testing. In an example scenario, an AB test may be executed in block 714. The purpose of an AB test is to compare two ad samples (e.g., versions or separate ads) in order to evaluate which exhibits better overall performance. The phases of an AB test are necessary to determine metrics of the ad. The results of the AB test (715) may indicate that one ad ran better, had more click-throughs, and an increased number of process completions. The AB test is helpful to update the training of the LLM models and help differentiate between a “good” or a “bad” ad. This feedback also helps make decisions based on real data rather than just theoretical assumptions.

According to a further embodiment, the LLM model may be retrained based on the result of the comparative (e.g., AB test). As described earlier and mentioned again in this embodiment, the profile of the user may include a budget, duration, location, target audience, or modality of an offered service. The attribute of one or more previous posts may include a heading, wording, formatting, visual or audio enhancements, audience reach, or optimal time of audience engagement. The LLM model may also be trained on account information of the user or a historical advertiser of the user.

### New Post Generation

According to another aspect of the subject technology, and as briefly introduced above, the GAI system 702 in FIG. 7 may receive an indication of a request from the user to generate a new posting with media content (703a). The media content may include an advertisement. The trained LLM model of the GAI system 702a on the back end 702 may assess the received indication based on the user profile, attribute of previous posts, or guidance provided by the user as described in detail above. In so doing, the GAI system 702a may be configured to generate the new post based on the assessment of the LLM model and transmit the new posting to the user via the user interface. The selected post may be based on the new post, and the media content may include advertisement generation data.

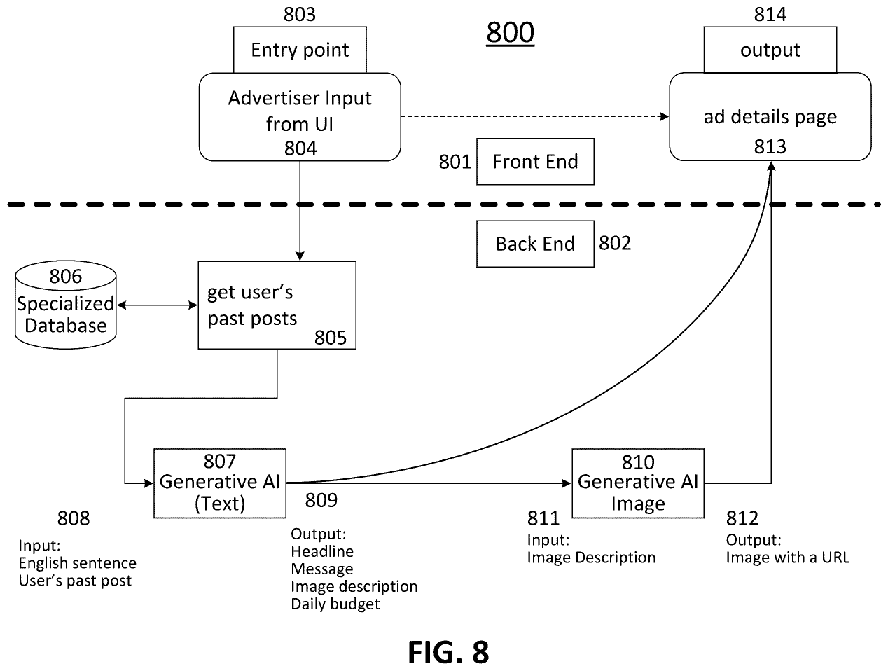

According to an embodiment of this aspect, FIG. 8 depicts an architecture 800 including a front end 801 and a back end 802. It is envisaged in one or more embodiments that the front end 801 and back end of 802 illustrated in FIG. 8 may be the front end 701 and back 702 end illustrated in FIG. 7. Or alternatively, one more functionalities in the back end 802 may be operated by the back end 702 system of FIG. 7 in view of a user request to generate a new post 703a

In regards to FIG. 8, the user may provide input, such as for example, advertiser input 804 via their user interface. The input method may include but is not limited to text or voice descriptions of what may be desired. The user may enter a full description or a partial description of their campaign. Alternatively, the user may enter nothing at all. Non-limiting examples of possible inputs from the user may include:

Describe the focus of the campaign e.g., “It's Christmas. Generate a gifting campaign.”

Set the duration: e.g., “run for 7 days.”

Specify the budget e.g., “spend $5 per day” or “spend $49 total.”

Set the audience e.g., “target 45+ year old people in Burlingame.”

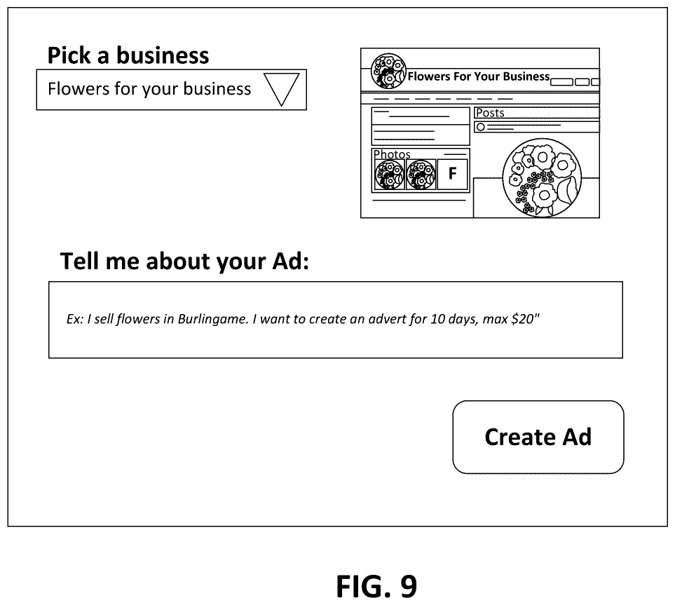

In an embodiment of this aspect, an ad creation user interface 900 is illustrated in FIG. 9. Here, the user interface 900 may include a drop-down menu for users with multiple business accounts to select from. For example, the business type may be related to flower. The user interface may include another entry box for informing the system about the type of add to generate. For example, for the relevant business directed to flowers an example ad may be, “I sell flowers in Burlingame. I want to create an advert for 10 days, max $20.” The user interface may also include a Create Ad button to initiate the GAI system to run the ad creation process. Doing so simplifies the user experience and produces an ad in a more efficient and effective capacity.

Upon obtaining input via the user interface 804, the GAI system in the back end 802 may gather information from a general database 805 and a special database 806 to obtain user history and other helpful analytics to generate a modified (e.g., optimized) ad. The specialized database 806 is a high-performance service for social graph data focusing on read-heavy workload and serves 30 billion queries per second. The specialized database provides Read-What-You-Write consistency and is optimized for very high read throughput.

Next upon completion of past-post processing 805, the received information, e.g., input 808, is parsed and processed via the GAI system 807. Doing so helps generate content for the ad creation flow, thereby simplifying the process. The output 809 includes headlines, messages, image descriptions and a daily budget.

The GAI system 807 subsequently generates an optimized campaign 809 based on any receive user guidance 808. An image description may also be input into another GAI system 810 to create an image or it may be input the GAI system 807 depending upon its capabilities to process both text and image data. The GAI system 810 (or 807) may output an image with a URL 812.

The GAI system 807 or 810 may make inferences based upon their trained LLM models. For example, the inferences may include but are not limited to:
(i) If the user does not enter any text, the LLM model makes inferences based on information such as the type of business, the location, the time of year, the typical customer demographic.
(ii) The GAI system generates content of the right tone for the business and its audience. For example, for a business dealing with a younger audience, it may include hashtags and emojis in the description. Meanwhile for a retired audience it would in a plain tone. The system may also infer if the ad should include photo content or video content.
(iii) Either define the audience based on direction given or in the absence of guidance, infer it from the characteristics of the business e.g., if it's a Burlingame restaurant, target people 20 miles around Burlingame.
(iv) Set the budget based on direction given. Absent direction, propose for example a budget based on the successful campaign history of similar businesses.
(v) Generate a campaign headline based on a summary of the campaign description.
(vi) Generate advertising text using either specific direction from input or gathers generic description based on context for this type of business.
(vii) Pick up on time-related data. For example, using the fact that it's Christmas, or National Ramen Day, or summer to generate an opportune ad.

Subsequently, the GAI system 807 and/or 810 in the back end 802 may transmit a created ad to a user via a user interface 813. For example, the ad may be presented to the user on an ad details page 813 as an output 814. Once the ad is generated and pushed to the ad details page 813, the user can either accept it and publish straight away or go in to edit.

Beyond the automatic generation of an ad as described above, an additional layer within this system could also identify beneficial advertising opportunities based on the performance of similar successful businesses. It may generate proposed ads and then proactively suggest them to an advertiser who could run them with a simple click. The tool could, for example:
(i) Find new opportunities for a business to advertise based on performance data of similar businesses that have achieved good results.
(ii) Identify key moments in a business's calendar and propose proactively a campaign. For example, notice that a greetings card business has not run an Ad in November and propose one in time for customers to buy cards for Hannukah.
(iii) Spot relevant social media trends indicating growing attention in a business segment and propose ads to businesses in that market.

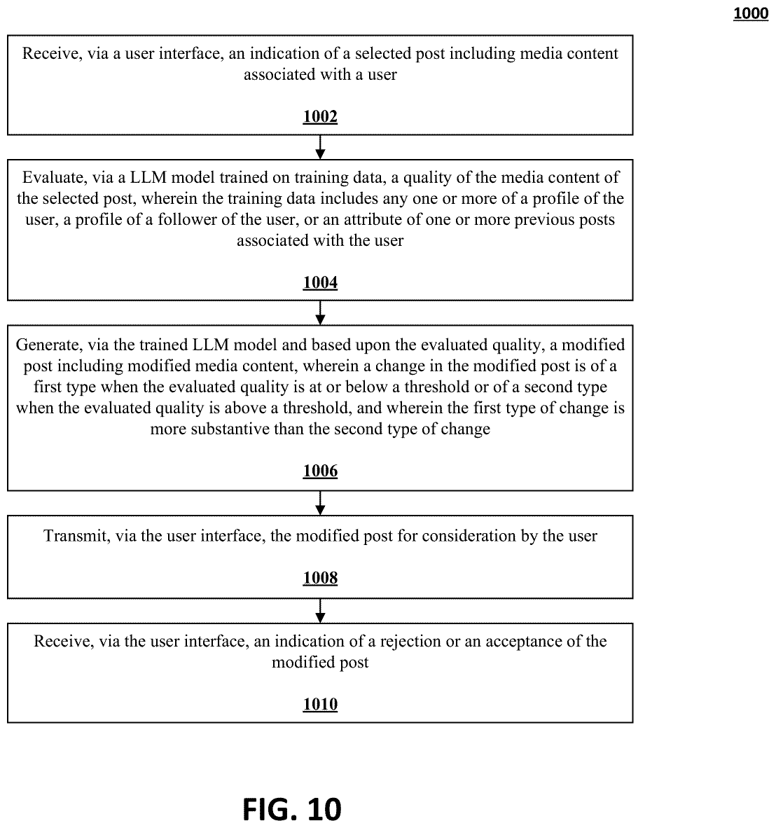

According to yet another embodiment, FIG. 10 depicts a flowchart of an example process 1000. In some implementations, one or more process blocks of FIG. 10 may be performed by a device. As shown in FIG. 10, process 1000 may include a step of receiving, via an user interface, an indication of a selected post including media content associated with an user (block 1002). For example, a device may receive, via an user interface, an indication of a selected post including media content associated with an user, as described above. As further shown in FIG. 10, process 1000 may include a step of evaluating, via a LLM model trained on training data, a quality of the media content of the selected post, where the training data includes any one or more of a profile of the user, a profile of a follower of the user, or an attribute of one or more previous posts associated with the user (block 1004). For example, a device may evaluate, via a LLM model trained on training data, a quality of the media content of the selected post, where the training data includes any one or more of a profile of the user, a profile of a follower of the user, or an attribute of one or more previous posts associated with the user, as described above.

FIG. 10's process 1000 may further include a step of generating, via the trained LLM model and based upon the evaluated quality, a modified post including modified media content, where a change in the modified post is of a first type when the evaluated quality is at or below a threshold or of a second type when the evaluated quality is above a threshold, and where the first type of change is more substantive than the second type of change (block 1006). For example, a device may generate, via the trained LLM model and based upon the evaluated quality, a modified post including modified media content, where a change in the modified post is of a first type when the evaluated quality is at or below a threshold or of a second type when the evaluated quality is above a threshold, and where the first type of change is more substantive than the second type of change, as described above. As even further shown in FIG. 10, process 1000 may include a step of transmitting, via the user interface, the modified post for consideration by the user (block 1008). For example, a device may transmit, via the user interface, the modified post for consideration by the user, as described above. As also shown in FIG. 10, process 1000 may include a step of receiving, via the user interface, an indication of a rejection or an acceptance of the modified post (block 1010). For example, device may receive, via the user interface, an indication of a rejection or an acceptance of the modified post, as described above. Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving, via a user interface, an indication of a selected post including media content associated with a user;
evaluating, via a large language model (LLM) trained on training data, a quality of the media content of the selected post, wherein the training data comprises any one or more of a profile of the user, a profile of a follower of the user, or an attribute of one or more previous posts associated with the user;
generating, via the trained LLM model and based upon the evaluated quality, a modified post comprising modified media content, wherein a change in the modified post is of a first type when the evaluated quality is at or below a threshold or of a second type when the evaluated quality is above a threshold, and wherein the first type of change is more substantive than the second type of change;
transmitting, via the user interface, the modified post for consideration by the user; and
receiving, via the user interface, an indication of a rejection or an acceptance of the modified post.

2. The method of claim 1, further comprising:
causing to perform, based upon the indication of the rejection or acceptance, a comparative test based upon the selected post and the modified post; and
retraining, based upon a result of the comparative test, the LLM model.

3. The method of claim 1, wherein the profile of the user comprises any one or more of a budget, duration, location of the user or audience, target audience, or modality of an offered service.

4. The method of claim 1, wherein the attribute of one or more previous posts comprises any one or more of a heading, wording, formatting, visual or audio enhancements, audience reach, or optimal time of audience engagement.

5. The method of claim 1, wherein the selected post is based upon an existing post on a media platform.

6. The method of claim 1, wherein the first type of change comprises one or more optimized views of the media content.

7. The method of claim 6, wherein the second type of change comprises a single optimized view of the media content.

8. The method of claim 1, further comprising:
receiving, via the user interface, an indication of a request to generate a new post including media content;
assessing, via the trained LLM based upon any one or more of the profile of the user, an account of the user, a historical advertiser of the user, the attribute of one or more previous posts, or guidance provided by the user, the received indication of the request;
generating, based upon the assessment, the new post; and
transmitting, via the user interface, the new post to the user.

9. The method of claim 1, wherein the media content comprises advertisement generation data.

10. The method of claim 9, wherein the media content of the selected post comprises any one or more of a caption, an image or a video.

11. The method of claim 2, wherein the comparative test comprises an AB test.

12. An apparatus comprising:
one or more processors; and
at least one memory storing instructions, that when executed by the one or more processors, cause the apparatus to:
receive, via a user interface, an indication of a selected post comprising media content associated with a user;
evaluate, via a large language model (LLM) trained on training data, a quality of the media content of the selected post, wherein the training data comprises any one or more of a profile of the user, a profile of a follower of the user, or an attribute of one or more previous posts associated with the user;
generate, via the trained LLM model and based upon the evaluated quality, a modified post comprising modified media content, wherein a change in the modified post is of a first type when the evaluated quality is at or below a threshold or of a second type when the evaluated quality is above a threshold; and
transmit, via the user interface, the modified post for consideration by the user.

13. The apparatus of claim 12, wherein when the one or more processors further execute the instructions, the apparatus is configured to:
cause to perform, based upon an indication of a rejection or an acceptance of the modified post, a comparative test based upon the selected post and the modified post; and
retrain, based upon a result of the comparative test, the LLM model.

14. The apparatus of claim 12, wherein the profile of the user comprises any one or more of a budget, duration, location of the user or audience, target audience, or modality of an offered service.

15. The apparatus of claim 12, wherein the attribute of one or more previous posts comprises any one or more of a heading, wording, formatting, visual or audio enhancements, audience reach, or optimal time of audience engagement.

16. The apparatus of claim 12, wherein the selected post is based upon an existing post on a media platform.

17. The apparatus of claim 12, wherein the first type of change comprises one or more optimized views of the media content, and wherein the second type of change comprises a single optimized view of the media content.

18. The apparatus of claim 12, wherein when the one or more processors further execute the instructions, the apparatus is configured to:
receive, via the user interface, an indication of a request to generate a new post comprising media content;
assess, via the trained LLM based upon any one or more of the profile of the user, the attribute of one or more previous posts, or guidance provided by the user, the received indication of the request;
generate, based upon the assessment, the new post; and
transmit, via the user interface, the new post to the user.

19. A non-transitory computer-readable medium storing instructions that, when executed, cause:
receiving, via a user interface, an indication of a selected post comprising media content associated with a user;
evaluating, via a large language model (LLM) trained on training data, a quality of the media content of the selected post, wherein the training data comprises any one or more of a profile of the user, a profile of a follower of the user, or an attribute of one or more previous posts associated with the user;
generating, via the trained LLM model and based upon the evaluated quality, a modified post comprising modified media content, wherein a change in the modified post is of a first type when the evaluated quality is at or below a threshold or of a second type when the evaluated quality is above a threshold, and wherein the first type of change is more substantive than the second type of change;
transmitting, via the user interface, the modified post for consideration by the user; and
receiving, via the user interface, an indication of a rejection or an acceptance of the modified post.

20. The computer-readable medium of claim 19, wherein the media content of the selected post comprises any one or more of a caption, an image or a video.
